(19) United States
(12) Patent Application Publication
(10) Pub. No.: US 2008/0090951 A1
(43) Pub. Date: Apr. 17, 2008

(54) Dispersion by Microfluidic Process

(75) Inventors: Dongsheng Mao, Austin, TX (US); Richard Lee Fink, Austin, TX (US); Zvi Yaniv, Austin, TX (US)

Correspondence Address: FISH & RICHARDSON P.C., P.O BOX 1022, Minneapolis, MN, 55440-1022, US

(73) Assignee: Nano-Proprietary, Inc., Austin, TX (US)

(21) Appl. No.: 11/757,272

(22) Filed: Jun. 1, 2007

Related U.S. Application Data
(63) Continuation-in-part of application No. 11/693,454, filed on Mar. 29, 2007.
(63) Continuation-in-part of application No. 11/695,877, filed on Apr. 3, 2007.
(60) Provisional application No. 60/819,319, filed on Jul. 7, 2006.
(60) Provisional application No. 60/810,394, filed on Jun. 2, 2006.
(60) Provisional application No. 60/788,234, filed on Mar. 31, 2006.
(60) Provisional application No. 60/810,394, filed on Jun. 2, 2006.
(60) Provisional application No. 60/789,300, filed on Apr. 5, 2006.
(60) Provisional application No. 60/810,394, filed on Jun. 2, 2006.

(51) Int. Cl. C08J 3/05; C08K 3/04; C08K 3/34; C08L 63/00

(52) U.S. Cl. 524/445; 524/495; 524/612; 977/742

(57) ABSTRACT

Improved mechanical properties of both clay and carbon nanotube (CNT)-reinforced polymer matrix nanocomposites are obtained by dispersing those nanoparticles using a microfluidic process. Well-dispersed particles are obtained that sufficiently improve mechanical properties of the nanocomposites, such as flexural strength and modulus.

This application for patent claims priority to U.S. Provisional Patent Application Ser. Nos. 60/819,319 and 60/810,394, which are hereby incorporated by reference herein. This application is a continuation-in-part of U.S. patent application Ser. No. 11/693,454, which claims priority to U.S. Provisional Application Ser. Nos. 60/788,234 and 60/810,394. This application is a continuation-in-part of U.S. patent application Ser. No. 11/695,877, which claims priority to U.S. Provisional Applications Ser. Nos. 60/789,300 and 60/810,394.

### TECHNICAL FIELD

The present invention relates in general to composite materials, and in particular, to composite materials that include carbon nanotubes.

### BACKGROUND INFORMATION

Nanocomposites are composite materials that contain particles in the size range of 1-100 nm. These materials bring into play the submicron structural properties of molecules. These particles such as clay and carbon nanotubes (CNTs) generally have excellent properties, a high aspect ratio and a layered structure that maximizes bonding between the polymer and particles. Adding a small quantity of these additives (0.5-5%) can increase many of the properties of polymer materials, including higher strength, greater rigidity, high heat resistance, higher UV resistance, lower water absorption rate, lower gas permeation rate, and other improved properties (See, T. D. Fornes, D. L. Hunter, and D. Dr. Paul, “Nylon-6 nanocomposites from Alkylammonium-modified clay: The role of Alkyl tails on exfoliation”, Macromolecules 37, 1793-1798(2004)).

However, dispersion of the nanoparticles is very important to reinforce polymer matrix nanocomposites. Up to now, dispersion of those nanoparticles in a polymer matrix has been a problem. Conventional dispersion methods such as ball milling, ultrasonication, and monogenization are not effective ways to disperse the particles. For example, a ball milling process takes a very long time to disperse the particles. Moreover, the particles are broken rather than dispersed. The energy of the ultrasonication process is not enough to disperse carbon nanotube ropes or layered clay particles. That is why those nanoparticle-reinforced nanocomposites do not achieve excellent properties as expected (See, Shamal K. Mhetre, Yong, K. Kim, Steven, B. Warner, Prabir, Phaneshwar, Katangur, and Autumn Dhanote, “Nanocomposites with functionalized carbon nanotubes,” Mat. Res. Soc. Symp. Proc. Vol. 788, L11.17.1-6 (2004); Chun-ki Lam, Kin-tak Lau, Hoi-yan Cheung, Hang-yin Ling, “Effect of ultrasound sonication in nanoclay clusters of nanoclay/epoxy composites,” Materials Letters 59, 1369-1372(2005)).

### BRIEF DESCRIPTION OF THE DRAWINGS

FIG. 1 illustrates a flow diagram configured in accordance with an embodiment of the present invention;

FIG. 2 illustrates a digital photo of a DWNT/acetone solution dispersed by a microfluidic machine on the left and an ultrasonicator on the right;

FIG. 3 illustrates an SEM image of a fracture surface of an epoxy/MWNT; and

FIG. 4 illustrates schematic diagrams of clay and CNTs in an epoxy matrix.

### DETAILED DESCRIPTION

A combination of clay and another type of particle may significantly improve the mechanical properties of polymer nanocomposites. The introduction of the particles in the clay/polymer matrix may prevent the agglomeration of the platelets. Small amounts of clay (<2 wt. %) and the other type of the particles (>1 wt. %) may significantly improve flexural strength and modulus of polymer matrix nanocomposites because of the well dispersion (or so-called exfoliation) of the clay platelets in the polymer matrix.

Improved mechanical properties of both clay and carbon nanotube (CNT)-reinforced polymer matrix nanocomposites are obtained by dispersing those nanoparticles using a microfluidic process. Well-dispersed particles are obtained that sufficiently improve mechanical properties of the nanocomposites, such as flexural strength and modulus.

Some advantages of the microfluidic dispersion process of the present invention over conventional dispersion methods are much higher energy applied to the solvent (up to 20,000 psi sustained), better control of the amount of energy applied, uniform and stable dispersions, and much smaller particles and droplet size.

Except for the clay and CNTs, other fillers such as graphite particles, carbon fibers, fullerenes, carbon nanotubes, and ceramic particles may also be utilized.

Epoxy resin (bisphenol-A) may be obtained from Arisawa Inc., Japan. The hardener (dicyandiamide) may be obtained from the same company. Both DWNTs and MWNTs may be obtained from Nanocyl, Inc., Belgium. Those CNTs may be functionalized with amino (—NH₂) functional groups. Amino-functionalized CNTs may help to improve the bonding between the CNTs and epoxy molecular chairs which may further improve the mechanical properties of the nanocomposites. Alternatively, pristine CNTs or functionalized by other ways (such as carboxylic functional groups) may also be utilized. Clay may be obtained from Nanocore, Inc. (product name: L30E). It is a natural montmorillonite modified with a ternary ammonium salt. Hereinafter, where the description discusses clay and carbon nanotube particles, it should be understood that the present invention is applicable to the use of clay particles by themselves, carbon nanotubes by themselves, or a combination of the two to mix with the epoxy.

The microfluidic machine may be purchased from Microfluidics Corp. Newton, Mass., US (Microfluidizer® Model 110Y, serial 2005006E). A microfluidic machine uses high-pressure streams that collide at ultra-high velocities in precisely defined micron-sized channels. Its combined forces of shear and impact act upon products to create uniform dispersions.

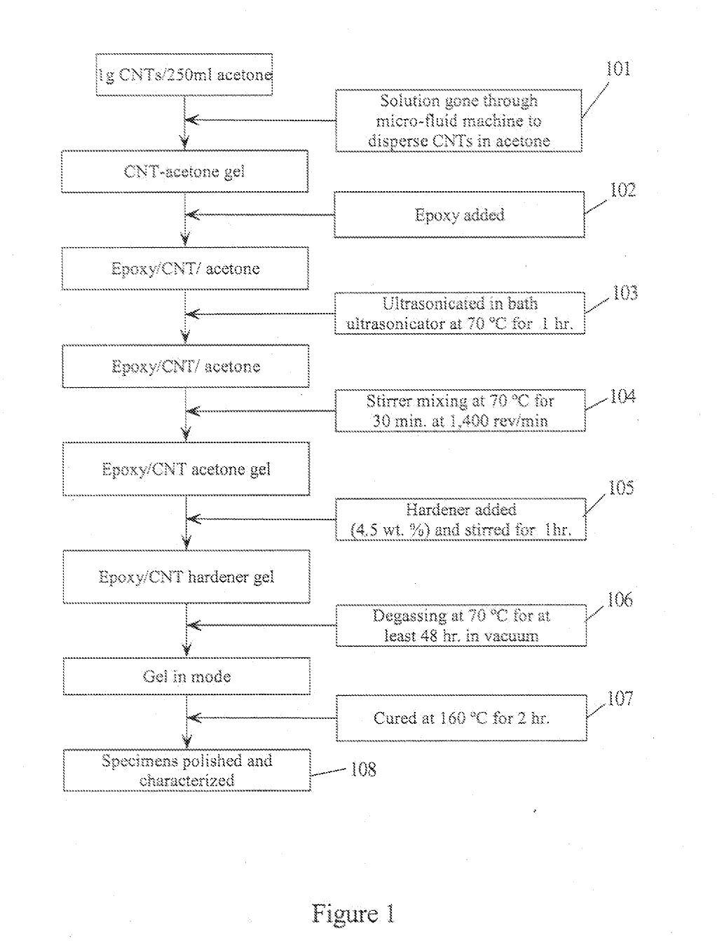

FIG. 1 illustrates an embodiment of a process flow to make epoxy/CNT nanocomposites or epoxy/clay nanocomposites or epoxy/clay/CNT nanocomposites. Hereinafter, the process will be described merely with respect to CNTs, though the present invention should be understood to apply to the aforementioned combinations of nanoparticles. All ingredients are dried in a vacuum oven at 70° C. for 16 hours to eliminate moisture. In step 101, the CNTs are put in acetone and dispersed by the microfluidic machine. The pressure may be set at 12,000 psi. Other solvents such as IPA, methanol, ethanol, or other epoxy-solvable or non-solvable may be used. The CNT/acetone is then formed as a gel, which means the CNTs are well dispersed in the acetone solvent. Other methods such as ultrasonication process may also be utilized. A surfactant may be also used to disperse CNTs in solution. In step 102, epoxy is then added to the CNT/acetone gel, which may be followed in step 103 by an ultrasonication process in bath at 70° C. for 1 hour. In step 104, the CNTs may be further dispersed in epoxy using a stirrer mixing process at 70° C. for half an hour at a speed of 1,400 rev/min. In step 105, a hardener may then added to the epoxy/CNT/acetone gel at a ratio of 4.5 wt. % followed by stirring at 70° C. for 1 hour. In step 106, the gel may be degassed in a vacuum oven at 70° C. for 48 hours. In step 107, the material may be then poured into a Teflon mold and cured at 160° C. for 2 hours. Mechanical properties (flexural strength and flexural modulus) of the specimens may be characterized after a polishing process in step 108.

Alternatively, the mixture of CNT/solvent/epoxy solution may go through the microfluidic machine to achieve uniform suspension with well dispersed CNTs in it.

Table 1 shows mechanical properties (flexural strength and flexural modulus) of nanocomposites manufactured in accordance with embodiments of the present invention. Flexural strength of epoxy/MWNTs (0.5 wt. %) has an increase of 18% of the flexural strength and 16% of the flexural modulus over the neat epoxy. Epoxy (DWNTs(0.5 wt. %)/MWNTs(0.5 wt. %) has an increase of 33% of the flexural strength and 18% of the flexural modulus over the neat epoxy. The best results so far from previous composites were 9-10% increase of the flexural strength of the epoxy/DWNTs(1 wt. %) over that of the neat epoxy (See, F. H. Gojny, M. H. G. Wichmann, U. Kopke, B. Fiedler, K. Schulte, “Carbon nanotube-reinforced epoxy-composites: enhanced stiffness and fracture toughness at low nanotube content”, Composites Science and Technology 64, 2363-2371(2004)). Both the flexural strength modulus of the epoxy/clay and epoxy/DWNT are improved compared with the neat epoxy.

TABLE 2

| | Flexural | Flexural |
|---|---|---|
| Epoxy material | strength (MPa) | modulus (GPa) |
| Neat epoxy | 116 | 3.18 |
| Epoxy/MWNTs (0.5 wt. %) | 137.4 | 3.69 |
| | (18% increase) | (16% increase) |
| Epoxy/DWNTs(0.5 wt. %)/ | 154.2 | 3.78 |
| MWNTs(0.5 wt. %) | (32% increase) | (19% increase) |
| Epoxy/clay (2 wt %) | 131.0 | 3.44 |

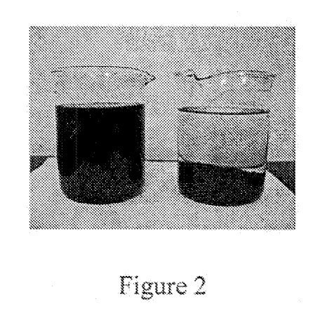

FIG. 2 shows the DWNT/acetone solution dispersed by a microfluidic machine (left beaker) and ultrasonicator (right beaker) (0.5 g DWNTs in 200 ml acetone in each beaker, the photograph was taken in 1 hour after the dispersion processes). It can be clearly seen that the suspension gone through the microfluidic machine is much more stable than the one dispersed by the ultrasonicator, which means that the CNTs are much better dispersed by the microfluidic machine.

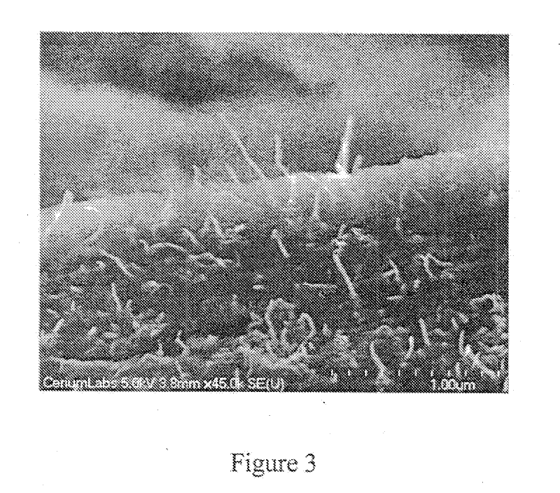

FIG. 3 shows an SEM image of the fracture surface of the epoxy/MWNT(0.5 wt. %). It can be seen that the CNTs are well dispersed into the individual CNTs.

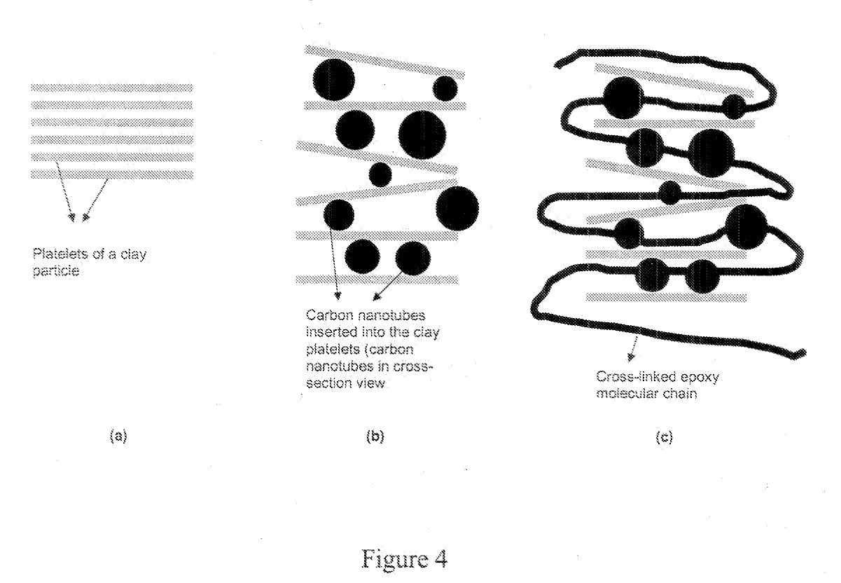

FIG. 4 illustrates schematic diagrams of the dispersion of platelets of clay with DWNTs. FIG. 4(a) illustrates the platelets in parallel of a clay particle. During the dispersion process, the platelets are separated from each other. The dispersed CNTs are inserted into the platelets to prevent them from agglomerating again, as can be seen in FIG. 4(b). After the epoxy is introduced into the clay/DWNT mixture, its molecular chain can pass through the gap between the platelets to form the cross-linked structure, which may substantially improve the mechanical properties of the nanocomposites, as illustrated in FIG. 4(c).

What is claimed is:

1. A method comprising:
dispersing nanoparticles in a solution with a microfluidic machine; and
mixing the solution of dispersed nanoparticles with an epoxy.

2. The method as recited in claim 1, wherein the solution comprises acetone.

3. The method as recited in claim 1, wherein the nanoparticles comprise carbon nanotubes.

4. The method as recited in claim 1, wherein the nanoparticles comprise clay nanoparticles.

5. The method as recited in claim 1, wherein the nanoparticles comprise graphite particles.

6. The method as recited in claim 1, wherein the nanoparticles comprise carbon fibers.

7. The method as recited in claim 1, wherein the nanoparticles comprise fullerenes.

8. The method as recited in claim 1, wherein the nanoparticles comprise ceramic particles.

9. The method as recited in claim 1, wherein the solution comprises a solvent.

10. The method as recited in claim 3, wherein the mixing step further comprises sonication of the solution and epoxy.

11. The method as recited in claim 1, further comprising adding a hardener.

12. A method comprising dispersing carbon nanotubes in a solvent with a microfluidic machine.

13. The method as recited in claim 12, further comprising mixing an epoxy with the solvent and dispersed carbon nanotubes.

14. The method as recited in claim 13, further comprising adding a hardener to create a CNT/epoxy/hardener gel.

15. The method as recited in claim 14, further comprising degassing the CNT/epoxy/hardener gel.

16. The method as recited in claim 15, further comprising curing the gel after degassing.

17. The method as recited in claim 17, wherein the mixing in of the epoxy comprises ultrasonication.
